(19) United States
(12) Patent Application Publication
(10) Pub. No.: US 2021/0375167 A1
(43) Pub. Date: Dec. 2, 2021

(54) DISPLAY SCREEN, COVER PLATE AND DISPLAY DEVICE

(71) Applicant: KUNSHAN GO-VISIONOX OPTO-ELECTRONICS CO., LTD., Kunshan (CN)

(72) Inventor: Li LIN, Kunshan (CN)

(73) Assignee: KUNSHAN GO-VISIONOX OPTO-ELECTRONICS CO., LTD., Kunshan (CN)

(21) Appl. No.: 17/404,398

(22) Filed: Aug. 17, 2021

Related U.S. Application Data
(63) Continuation of application No. PCT/CN2020/076229, filed on Feb. 21, 2020.

(30) Foreign Application Priority Data
Jun. 5, 2019 (CN) 201910486415.7

(51) Int. Cl. G09F 9/30; G06F 1/16

(52) U.S. Cl. CPC G09F 9/301; G06F 1/1656; G06F 1/1652

(57) ABSTRACT

A display screen includes a flexible display panel, and a cover plate having a first region and a second region which is located on at least one side of the first region and contiguous to the first region, the cover plate is configured to be bendable together with the flexible display panel; and the cover plate includes: a first base provided in the first region, and a second base provided in the second region and connected to the first base; an elastic modulus of the first base is greater than an elastic modulus of the second base. A cover plate, a display screen and a display device are provided.

### CROSS REFERENCE TO RELATED APPLICATIONS

The present application is a continuation application of the PCT application No. PCT/CN2020/076229, filed on Feb. 21, 2020, which claims priority to Chinese Patent Application No. 201910486415.7, filed on Jun. 5, 2019, and the contents of the both applications are herein incorporated by reference in their entirety.

### TECHNICAL FIELD

The present disclosure relates to the field of display technology, and particularly to a display screen, a cover plate and a display device.

### BACKGROUND

With the development of display technology, functions of terminal devices such as mobile phones have become more and more diversified, and requirements for various performances of the display screen have gradually increased. The flexible display screen can be bent or folded by using the flexibility of the flexible display screen, thereby bringing convenience for users to use and carry. However, most of the conventional flexible display screens adopt the cover plates made of flexible or rigid materials. The cover plate made of the flexible material does not have enough hardness to well protect the display screen; while the cover plate made of the rigid material has lower bendability, which is not conducive to the bending of the flexible display screen.

### SUMMARY

In view of this, it is necessary to provide a display screen, a cover plate and a display device, to obtain a better hardness and bendability, and to improve the reliability of the product.

In one aspect of the present disclosure, a display screen is provided, which includes:

a flexible display panel;

a cover plate, having a first region and a second region which is located on at least one side of the first region and contiguous to the first region, wherein the cover plate is configured to be bendable together with the flexible display panel, and the cover plate includes:

a first base provided in the first region; and

a second base provided in the second region and connected to the first base, wherein an elastic modulus of the first base is greater than an elastic modulus of the second base.

In the above-mentioned display screen, the first base and the second base are arranged in the first region and the second region correspondingly, and the elastic modulus of the first base is greater than the elastic modulus of the second base, so that a greater flatness and hardness can be provided to a part of the display screen corresponding to the first region (flat region); and the elastic modulus of the second base is smaller, which can provide a greater capacity of stress absorption and a greater capacity of impact resistance to a part of the display screen corresponding to the second region (bending region), which is beneficial to the bending of the display screen and the protection of the sides of the display screen, so that the sides of the display screen have a better capacity of impact resistance.

In another aspect of the present disclosure, a display device is provided, which includes the display screen of the above-mentioned embodiment.

In another aspect of the present disclosure, a cover plate is provided, which has a first region and a second region which is located on at least one side of the first region and contiguous to the first region, the cover plate includes:

a first base provided in the first region; and

a second base provided in the second region and connected to the first base, wherein an elastic modulus of the first base is greater than an elastic modulus of the second base.

### BRIEF DESCRIPTION OF THE DRAWINGS

FIG. 1 is a schematic cross-sectional view of a display screen according to an embodiment of the present disclosure.

FIG. 2 is a schematic cross-sectional view of a cover plate of the display screen shown in FIG. 1.

FIG. 3 is a schematic structure diagram of a cover plate of a display screen according to an embodiment of the present disclosure, in which both sides of the cover plate are bent to form two arc trenches respectively.

FIG. 4 is a schematic structure diagram of a U-shaped cover plate of a display screen according to an embodiment of the present disclosure.

FIG. 5 is a schematic structure diagram of a 360-degree fully-enclosed cover plate of a display screen according to an embodiment of the present disclosure.

FIG. 6 is a schematic cross-sectional view of an auxiliary cover layer according to an embodiment of the present disclosure.

FIG. 7 is a flow chart showing a method for manufacturing a display screen according to an embodiment of the present disclosure.

FIG. 8 is a flow chart showing a method for manufacturing a display screen according to another embodiment of the present disclosure.

FIG. 9 is a schematic cross-sectional view of a display screen corresponding to step S130.

### DETAILED DESCRIPTION

In order to facilitate the understanding of the present disclosure, the present disclosure will be described more comprehensively below with reference to the relevant accompanying drawings. The drawings show some embodiments of the disclosure. However, the present disclosure can be implemented in many different forms and is not limited to the embodiments described herein. Rather, the purpose of the embodiments is to make the understanding of the present disclosure more thorough and comprehensive.

Unless otherwise defined, all technical and scientific terms used herein have the same meaning as commonly understood by those skilled in the technical field of the present disclosure. The terms used in the specification of the disclosure herein are only for the purpose of describing specific embodiments, rather than limiting the present disclosure. The term “and/or” as used herein includes any and all combinations of one or more related listed items.

With the continuous development of communication technology, the functions of terminal devices such as mobile phones are becoming more and more diversified. In order to meet users' requirements for diversified terminal devices and high experience, in addition to full-screen terminal devices, double-screen terminal devices have appeared in the market. However, most of the double-sided screen terminal devices in the related technology are equipped with a main screen on the front and a secondary screen on the back. The main screen is separated from the secondary screen by a metal middle frame. Such terminal device gives a sense of fragmentation in terms of look and feel, and the user experience is not high. With the continuous development and utilization of the flexible characteristics of the flexible display, the flexible display panel can be bent to simultaneously display on the front and side of the product, as well as the front, side and back of the product, so as to achieve a higher screen-to-body ratio, thereby improving user experience.

The material of the flexible display panel in the related technology has a surface with low hardness and weak strength, in order to improve the service life of the flexible display screen, direct operation on the flexible display panel should be avoided, and a cover plate is needed to protect the flexible display panel. Therefore, for the flexible display screen, the cover plate should also have a sufficient rigidity and an ability to bend repeatedly. However, although the glass cover plate in the related art has a relatively high hardness (usually above 7H), the bending performance of the glass cover plate is very low. However, the hardness of the surface of the flexible film cover plate (for example, a polymer film) with a better bending performance is lower (usually only 2H).

At the same time, with the development of curved surface display technology, a bilateral surface, a quadrilateral surface, and even the aforementioned display devices of 360-degree fully-enclosed screen are rapidly entering the market. In the field of curved surface display technology, the fit between the flexible display panel and the cover plate, as well as the subsequent assembly of the terminal are also a technical difficulty in the production process of the curved surface display devices. For example, for the curved surface design which is tending to bend inward, even the 360-degree fully-enclosed curved surface display device, it is difficult to perform the fit between the flexible display panel and the glass cover plate, as well as the subsequent assembly of the terminal. However, the hardness of the surface of the flexible film cover plate is low, it is difficult to protect the flexible display panel, and the normal assembly of the terminal cannot be guaranteed.

In addition, neither of them has a strong ability of impact resistance to an external force. For example, for a terminal device with a 360-degree fully-enclosed screen on the market, the reliability of the display screen when dropped or bent is the most concerned aspect to users, and is also a symbol of the reliability in the eyes of users. For drops in daily use, devices are dropped from users' hands, backpacks or tables in most cases, and the height is usually in a range of 0.8 to 1.2 m. In the course of research, the inventors found that when such terminal device with a curved surface display screen is dropped, the hardness and the impact resistance of the cover plate in the related technology cannot meet the requirements of drop resistance, especially the bending area of the flexible display screen (a side display area) is easily in contact with the rigid interface, the bending area of the flexible display screen will be subjected to a greater stress, thereby making the bending area of the flexible display screen being in a failure state after the drop of the flexible display screen.

In order to solve the aforementioned problem, the present disclosure provides a display screen.

Before detailing the present disclosure, some technical terms are first defined and explained.

An elastic modulus refers to a stress in a unidirectional stress state divided by a strain in this direction. Specifically, the elastic modulus indicates a direct proportional relationship between the stress and the strain when a material is in an elastic deformation stage, and the proportionality factor is called the elastic modulus. The elastic modulus is reflected in three aspects, specifically as follows.

1) Young's modulus: a linear stress divided by a linear strain is equal to the Young's modulus of a material. For example, a pulling force F is applied to a thin rod, the pulling force F divided by the cross-sectional area S of the rod is called the “linear stress”, and an elongation dL of the rod divided by an original length L is called the “linear strain”.

2) Shear modulus: a shear stress divided by a shear strain is equal to the shear modulus of a material. For example, if a lateral force F (such as a frictional force) is applied to a piece of elastic body, the elastic body is deformed from a square to a rhombus. An angle of the deformation is called the “shear strain”, and the corresponding force F divided by an area of stressed surface S is called the “shear stress”.

3) Bulk modulus: a bulk stress divided by a bulk strain is equal to the bulk modulus. For example, an overall pressure P is applied to an elastic body. This pressure is called the “bulk stress”, and the bulk reduction dV of the elastic body divided by an original bulk V is called the “bulk strain”.

Hardness: an ability of a material to locally resist a hard object from pressing into a surface thereof is called the “hardness”, which includes three types of a scratch hardness, an indentation hardness, and a shore hardness.

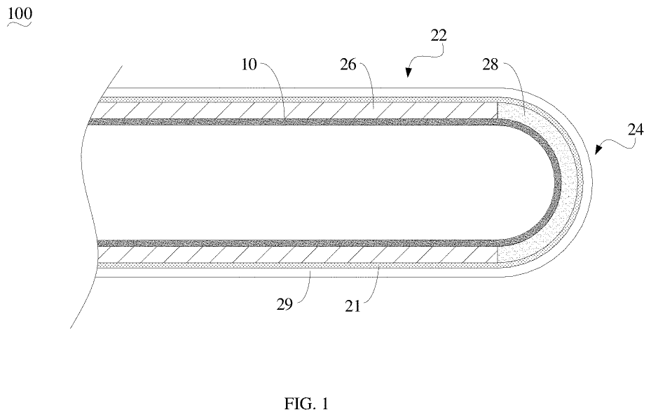

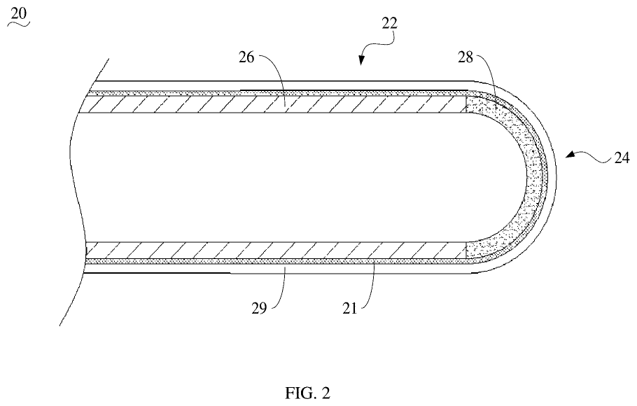

FIG. 1 shows a schematic structure diagram of a display screen in an embodiment of the present disclosure. FIG. 2 shows a schematic cross-sectional view of a cover plate of the display screen shown in FIG. 1. For ease of description, only parts related to the embodiments of the present disclosure are shown.

Referring to FIG. 1 and FIG. 2, the display screen 100 in an embodiment of the present disclosure includes a flexible display panel 10 and a cover plate 20, and the flexible display panel 10 is attached to a surface of one side of the cover plate 20.

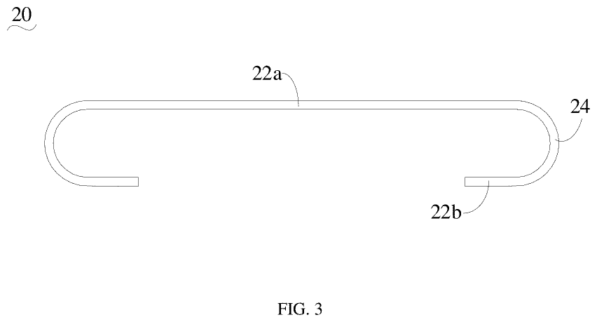

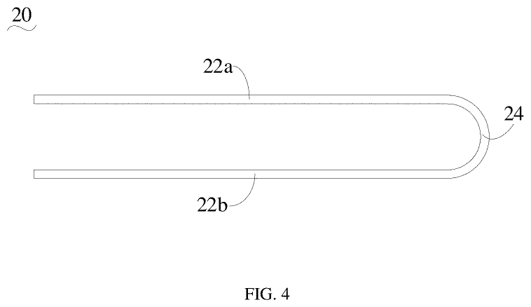

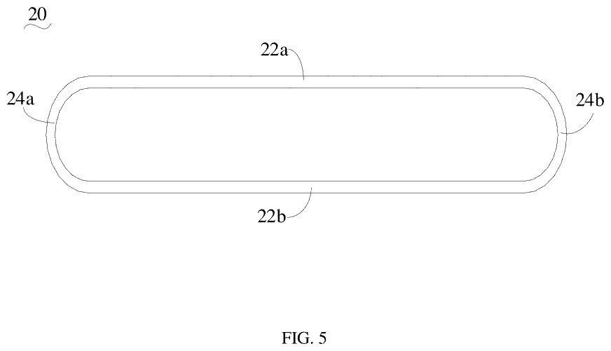

The cover plate 20 is configured to be bendable together with the flexible display panel 10, the cover plate 20 is configured to protect the flexible display panel 10 to reduce the impact of external shock on the display panel, and the cover plate 20 can simultaneously provide a certain surface hardness for the display screen 100 to facilitate subsequent assembly of the terminal. For example, different bending forms of the display screen 100 can implement different forms of curved surface display. In the embodiment as shown in FIG. 3 (only the cover plate 20 is shown), both sides of the flexible display panel 10 and the cover plate 20 can be integrally bent back to form two arc trenches respectively. In the embodiment as shown in FIG. 4 (only the cover plate 20 is shown), the flexible display panel 10 and the cover plate 20 can be integrally bent to form a U shape, so that the display screen 100 can implement an U-shaped curved surface display on the front, the back and one side of the product (for example, a mobile phone terminal). In the embodiment as shown in FIG. 5 (only the cover plate 20 is shown), the flexible display panel 10 and the cover plate 20 are integrally bent to form a 360-degree fully-enclosed structure, so that the circumferential 360-degree fully-enclosed display can be implemented on the front, back and at least two sides of the product. In a word, the form in which the display screen 100 can be bent is not limited to these, but the cover plate 20 and the flexible display panel 10 are integrally bent, thereby protecting the display module and touch control module of the flexible display panel, the cover plate 20 can reduce the impact of the external shocks on the display screen, and the cover plate 20 simultaneously provides a certain surface hardness for the display screen 100.

The cover plate 20 has a first region 22 and a second region 24 which is located on at least one side of the first region 22 and contiguous to the first region 22. For example, as shown in FIGS. 2 to 4, the first region 22 can be a flat region, and the second region 24 can be a bending region (an arc trench region), and there is a smooth transition between the second region 24 and the first region 22. It is easy to understand that when the display screen 100 is not bent, the first region 22 and the second region 24 are both flat regions, but the second region 24 becomes a bending region after the display screen 100 is bent. The second region 24 can be located on a plurality of sides of the first region 22. In an embodiment, as shown in FIG. 4, the first region 22 can include a first sub-region 22a and a second sub-region 22b; the first sub-region 22a and the second sub-region 22b are respectively located on both sides of the second region 24. Two opposite sides of the second region 24 (bending region) of the cover plate 20 are respectively connected to the first sub-region 22a and the second sub-region 22b (flat region). At this time, the second region 24 is located on one side of any sub-region in the first region. As shown in FIG. 5, the second region 24 can include a third sub-region 24a and a fourth sub-region 24b; the cover plate 20 has a first sub-region 22a and a second sub-region 22b, and a third sub-region 24a and a fourth sub-region 24b. The two sides of the third sub-region 24a are respectively connected to one side of the first sub-region 22a (flat region) and one side of the second sub-region 22b (flat region), and two sides of the fourth sub-region 24b are respectively connected to the other side of the first sub-region 22a (flat region) and the other side of the second sub-region 22b (flat region). More precisely, the first sub-region 22a and the second sub-region 22b are middle regions (front and back) of the cover plate 20, and are also relatively flat regions of the cover plate 20. The second region 24 is located on one side or two sides of the cover plate 20 in the horizontal or vertical direction, i.e., the second region 24 is a part formed by bending back at one side or two sides of the first region 22 in the horizontal or longitudinal direction. For example, the third sub-region 24a/fourth sub-region 24b located on one side of the first sub-region 22a/second sub-region 22b can be in a semicircle shape which is tangent to the first sub-region 22a/second sub-region 22b when the display screen 100 is bent.

It can be appreciated that, in other embodiments, the cover plate 20 and the display screen 100 can tend to bend inward, that is, bend toward the flexible display panel. For example, as shown in FIG. 3, the first sub-region 22a and the second sub-region 22b located on both sides of the second region 24 in the cover plate 20 are parallel to each other, that is, a bending angle of the display screen 100 is 180 degrees. Certainly, in some other embodiments, the first sub-region 22a and the second sub-region 22b located on both sides of the second region 24 in the cover plate 20 may not be parallel to each other, that is, the bending angle of the display screen 100 can be in a range of 90 degrees to 180 degrees, or even be greater than 180 degrees. There may be no clear boundary between the first region 22 and the second region 24 of the display screen 100, and the second region 24 can also include a part of the first region 22.

The flexible display panel 10 can be a flexible organic light-emitting display panel, and specifically can be a flexible OLED light-emitting display panel. The flexible display panel 10 can also be other flexible and bendable screens, such as a Micro LED flexible display panel, a quantum dot flexible display panel, etc., which are not limited herein. The flexible display panel 10 has a light-emitting side, and the cover plate 20 is located on the light-emitting side of the flexible display panel 10. For example, in the embodiment shown in FIG. 1, the outer surface of the flexible display panel 10 is a light-emitting surface, and the cover plate 20 is fitted to the light-emitting surface of the flexible display panel 10. The cover plate 20 can be bonded to the flexible display panel 10 through an OCA adhesive layer or a TPU adhesive layer, or through an electrostatic attachment, which is not limited here. In some embodiments, the flexible display panel 10 includes a display panel body and a polarizer, and the polarizer is provided between the display panel body and the cover plate 20. In other words, the polarizer is fitted to the light-emitting surface of the display panel body before the cover plate 20 is fitted to the display panel body.

In the embodiment of the present disclosure, as shown in FIG. 2, the cover plate 20 includes a first base 26 and a second base 28. The first base 26 is provided in the first region 22, and the second base 28 is provided in the second region 24. The second base 28 and the first base 26 are connected to each other, and the elastic modulus of the first base 26 is greater than that of the second base 28. For example, the first base 26 and the second base 28 can be made of different materials. In a specific embodiment, compared to the first base 26, the second base 28 can be made of a material with a greater tensile strength and a greater capability of stress absorption; and compared to the second base 28, the first base 26 can be made of a material with greater hardness and flatness.

It should be appreciated that from a macro perspective, the elastic modulus is a measure of the ability of an object to resist elastic deformation; from a micro perspective, the elastic modulus reflects the bond strength between atoms, ions, or molecules. When the display screen 100 is bent, the display screen 100 is subjected to the tensile stress and the compression stress along the bending direction. The first base 26 is mainly subjected to the tensile stress, while the second base 28 is mainly subjected to the compression stress. The tensile stress is generally less than the compression stress. Therefore, the elastic modulus of the first base 26 is greater than the elastic modulus of the second base 28, which can provide a greater flatness and hardness for a region of the display screen 100 corresponding to the first region 22; and the elastic modulus of the second base 28 is smaller, which can provide a greater capability of stress absorption and a greater capability of impact resistance for a region of the display screen 100 corresponding to the second region 24 (bending region), thereby facilitating the bending of the display screen 100, and the protection of a side of the display screen 100 is achieved, such that the side of the display screen 100 has a higher impact resistance. In addition, the first base 26 and the second base 28 are connected to each other, which cannot affect the overall hardness of the display screen 100, and this is beneficial to the subsequent assembly of the terminal, and this will not bring other bad experiences.

It should be noted that since the first base 26 and the second base 28 are arranged in different regions, the molding process can also be changed. For example, the glass cover plate of the 360-degree fully-enclosed screen in the related design is difficult to fit to the flexible display panel 10, and this is not beneficial to the subsequent assembly of the terminal. However, in present disclosure, the bases with different elastic modulus are arranged in different regions, the flexible display panel 10 can be bent into a specific shape in advance, and then the first base 26 and the second base 28 are formed on the flexible display panel 10. Compared to the molding manners in related technologies, on one hand, the possibility of stress concentration during the production process and bending process of the display screen is reduced to a certain extent, thereby improving the reliability of the display screen; on the other hand, it is convenient for the fitting between the cover plate and the display panel, as well as the subsequent assembly of the terminal, the present disclosure has the advantages of easy manufacture and assembly especially for the U-shaped display screen (as shown in FIG. 4) and 360-degree fully-enclosed display screen (as shown in FIG. 5).

In some embodiments, the first base 26 can be made of toughened glass, the toughened glass is also called tempered glass, which is a glass with a compression stress on the surface, i.e., which is obtained by strengthening the glass with a tempering method. The toughened glass can provide a greater hardness and flatness to the first region 22 of the cover plate 20, which can improve the impact resistance of the display screen 100. In other embodiments, the first base 26 can be ultra-thin glass. The ultra-thin glass has the rigidity characteristic of the glass materials and also has a certain bendability. Therefore, the ultra-thin glass can not only make the cover plate 20 of the display screen 100 ultra-thin, but also make it have a better bendability and a sufficient hardness.

Further, a thickness of the first base 26 is in a range of 0.1 mm to 1 mm. It is easy to understand that the thickness of the first base 26 affects various physical properties of the cover plate 20 to a certain extent. For example, the greater the thickness of the cover plate 20 is, the stronger the rigidity and the impact resistance of the cover plate 20 is, but the bendability and the flatness of the cover plate 20 may be affected to a certain extent; the smaller the thickness of the cover plate 20 is, the greater the bendability and the flatness of the cover plate 20 is, but the hardness and the impact resistance of the cover plate 20 may decrease. In addition, in order to facilitate the internal space design of terminal products such as mobile phones, the thickness of the cover plate 20 tends to be thinner, but the aforementioned hardness, flatness and impact resistance need to be taken into consideration. The applicant of the present disclosure found that the thickness range of the first base 26 is set to a range of 0.1 mm to 1 mm, which can make the cover plate 20 ultra-thin while having a better bendability, a sufficient hardness and a reliable capacity of impact resistance.

In some embodiments, the second base 28 can be made of an energy-absorbing material, that is, the second base 28 has a capacity of stress absorption greater than that of the first base 26. The second base 28 completely covers the second region 24 and is connected to the first base 26. For example, in some embodiments, the energy-absorbing material can be Optical Clear Resin (OCR), which completely covers the second region 24 of the display screen 100. The OCR can restrain the light scattering caused by external light and backlight, the OCR has a refractive index and a light transmittance similar to the glass, and the OCR is resistant to yellowing, and the OCR can withstand expansion-shrinkage contraction rates of a plurality of different substrates, which can solve a problem caused by the temperature change between the high temperature and low temperature. In addition, the OCR has an ability of rapid reaction to the UV light and an ability of molding due to the UV light, and the OCR can be produced by various manners such as dispensing or coating, and then solidified by the UV, and the production process is simple. It is worth emphasized that the OCR also has a strong ability of absorbing the stress. When the OCR is provided in the second region 24, the OCR can provide the side surface (curved arc-surface) of the display screen 100 with a strong impact resistance, thereby improving the reliability of the display screen 100.

For another example, in some other embodiments, the energy-absorbing material is clear silica gel. The clear silica gel is a colorless or skin-colored oily liquid, which becomes a soft elastic material after vulcanization. Such elastic material can be used for a long time in a temperature range of −65° C. to 200° C. with soft and elastic properties maintained, and such elastic material has electrical properties and chemical stability, water resistance, ozone resistance, weather resistance, non-corrosiveness, and physiological inertia, non-toxic, tasteless, and low linear shrinkage rate. In such a way, the clear silica gel can provide the second region 24 of the cover plate 20 with greater hardness, greater flatness and greater performance of stress absorption, and accordingly the reliability of the display screen 100 can be improved. It can be understood that, as an embodiment, the refractive index of the clear silica gel is adjustable to be suitable for display devices in different application scenarios.

In some embodiments of the present disclosure, as shown in FIG. 1, the cover plate 20 further includes an auxiliary cover plate layer 29. The auxiliary cover plate layer 29 is provided on a side of the first base 26 and the second base 28 away from the flexible display panel 10. In such a way, the integrity of the surface of the display screen 100 can be improved, and a good touch feeling can be provided, and the auxiliary cover plate layer 29 can also provide a protective effect, thereby further improving the reliability of the display screen 100.

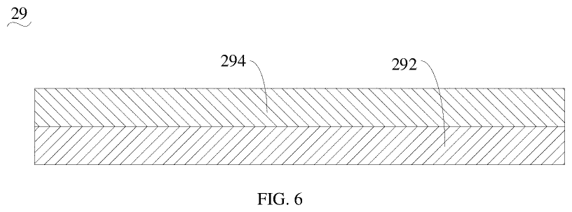

FIG. 6 shows a schematic cross-sectional view of an auxiliary cover plate layer 29 according to an embodiment of the present disclosure.

Further, the auxiliary cover plate layer 29 has a composite stacked structure, and at least includes a flexible glass layer 292 and an organic layer 294 stacked on the flexible glass layer 292. In such a way, the rigidity of the glass material can be utilized to further guarantee the hardness of the cover plate 20, thereby protecting the display screen 100. The flexibility of the organic material can utilized to improve the bendability of the cover plate 20, so that the display screen 100 can achieve a better bendability; and the organic material can also release a part of the external force through the deformation under the impact of the external force, to reduce the impact of the external force on the cover plate 20 and the display screen 100 and improve the bendability of the cover plate 20; at the same time, after the flexible glass layer 292 is damaged due to a strong external force, fragments of the flexible glass layer 292 can adhere to the organic layer 294 to prevent the fragments from scattering and damaging the display screen 100.

For example, the material of the flexible glass layer 292 can be ultra-thin glass, and the material of the organic layer 294 can include at least one of polyimide (PI), clear polyamide (CPI), polyethylene (PE), and polymethyl methacrylate (PMMA). It can be understood that the number of the flexible glass layers 292 and the organic layers 294 can be two or more, which is not limited herein. Considering the thickness of the auxiliary cover plate layer 29, and based on purposes of improving the integrity of the surface of the display screen 100, providing a good touch feeling, and having a function of protecting, as an embodiment, the auxiliary cover plate layer 29 can include an ultra-thin glass layer and a clear polyamide (CPI) layer stacked with the ultra-thin glass layer.

It can be understood that the number of the flexible glass layers 292 and the organic layers 294 is not limited herein, for example, both can be two or more. In addition, the stacking order of the flexible glass layer 292 and the organic layer 294 is not limited, and they can or cannot be alternately stacked.

In an embodiment, an optical adhesive layer 21 can be provided to bond the flexible glass layer 292 to the organic layer 294, and an optical adhesive layer 21 also can be provided to bond the auxiliary cover plate layer 29 to the first base 26 and the second base 28. Specifically, the optical adhesive layer 21 is Optical Clear Adhesive (OCA). The OCA has colorless and transparent properties with a light transmittance greater than 90%, and has a good bonding strength, and can be solidified at a room temperature or a medium temperature and has a small curing shrinkage rate, and other characteristics. By providing the OCA to bond the flexible glass layer 292 to the organic layer 294, and bond the auxiliary cover plate layer 29 to the first base 26 and the second base 28, stable bonding can be achieved without affecting the display effect of the display screen 100. Moreover, by providing the OCA layer, when the cover plate 20 is impacted by an external force, the OCA layer can also absorb and release a part of the external force, which can reduce the impact of the external force on the cover plate 20 and the flexible display panel 10.

It should be understood that in the present disclosure, different adhesives can be selected according to different application scenarios to achieve the bonding between the flexible glass layer 292 and the organic layer 294, and the bonding between the auxiliary cover plate layer 29 and the base. The selected adhesive can guarantee a better bonding strength without affecting the display effect, and the specific type is not limited herein.

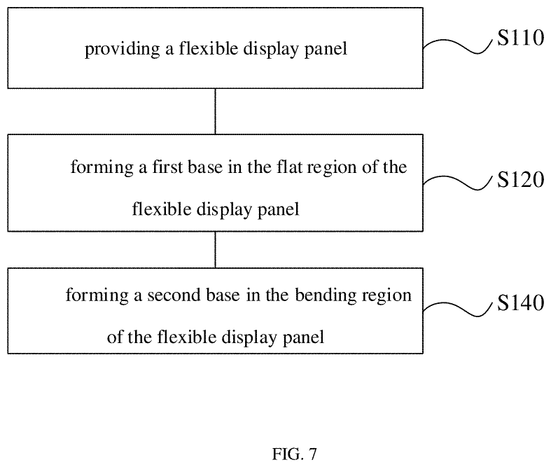

FIG. 7 shows a flow chart of a method for manufacturing a display screen 100 according to an embodiment of the present disclosure.

Referring to FIG. 7, in order to obtain a better understanding of the technical effects of the present disclosure, a method for manufacturing a display screen 100 is provided, which includes the following steps.

Step S110: a flexible display panel 10 is provided.

Step S120: a first base 26 is formed in a flat region of the flexible display panel 10.

Step S140: a second base 28 is formed in a bending region of the flexible display panel 10.

In the step S110, the flexible display panel 10 has the flat region and the bending region located on at least one side of the flat region. In a specific embodiment, the flexible display panel 10 can be bent into a predetermined shape, for example, bended into a structure with a U-shaped cross-section or a 360-degree fully-enclosed cross-section, and the flat region is located on opposite two sides of each bending region.

In the step S120, the optical adhesive layer 21 can be utilized to bond the first base 26 to the flexible display panel 10. More specifically, the optical adhesive layer 21 can be Optical Clear Adhesive (OCA).

In the step S140, the second base 28 made of an energy-absorbing material can be bonded to the flexible display panel 10 through the optical adhesive layer 21, and the second base 28 is connected to the first base 26. The elastic modulus of the first base 26 is greater than the elastic modulus of the second base 28. As an embodiment, the energy-absorbing material is Optical Clear Resin (OCR) or clear silica gel.

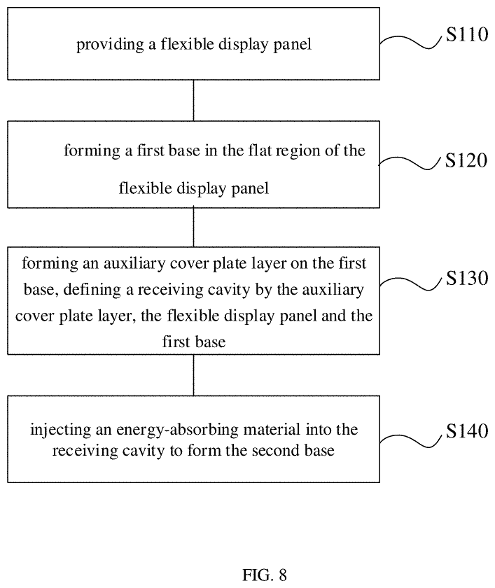

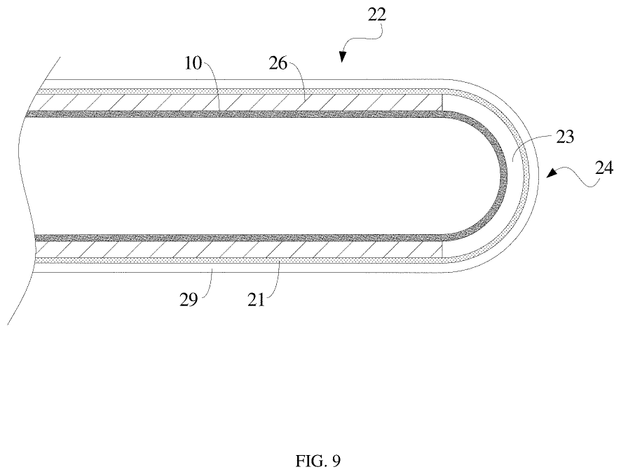

FIG. 8 is a flow chart showing a method for manufacturing a display screen 100 according to another embodiment of the present disclosure; and FIG. 9 shows a schematic cross-sectional view of the cover plate corresponding to the step S130.

In an embodiment, the first region 22 is located on both sides of the second region 24. Before the step S140, the method further includes following step.

Step S130: an auxiliary cover plate layer 29 is formed on the first base 26, a receiving cavity 23 is defined by the auxiliary cover plate layer 29, the flexible display panel 10 and the first base 26.

Specifically, a flexible glass layer 292 and an organic layer 294 can be sequentially formed on the first base 26 to define the aforementioned receiving cavity 23. The flexible glass layer 292 is bonded to the organic layer 294 by Optical Clear Adhesive (OCA). In a specific embodiment, the material of the flexible glass layer 292 can be ultra-thin glass, and the material of the organic layer 294 can include at least one of polyimide (PI), clear polyamide (CPI), polyethylene (PE), and polymethyl methacrylate (PMMA).

Accordingly, the second base 28 can be formed by injecting energy-absorbing material into the receiving cavity 23. In such a way, on one hand, the possibility of stress concentration during the production process and the bending process of the display screen 100 is reduced, thereby improving the reliability of the display screen 100; on the other hand, compared to the prior art, it is easier to fit the cover plate 20 to the display panel, and especially it is convenient to manufacture and assemble the U-shaped screen and 360-degree fully-enclosed screen.

In an embodiment, the step S140 specifically includes:

the energy-absorbing material is injected into the receiving cavity 23 to form the second base 28.

Specifically, the energy-absorbing material is the Optical Clear Resin (OCR) or clear silica gel. It should be understood that, there is a material with a smaller elastic modulus compared to the tempered glass or ultra-thin glass in the prior art, such as thermoplastic polyurethanes (TPU), when used in the subsequent processes, such material has a higher temperature, and the flexible display panel 10 is easy to in a failure state at the high temperature; when the material of clear resin or clear silicone formed by injection molding is used, the temperature in the process is lower, and the material can be molded by heat curing or UV curing. In such a way, the production yield of the display screen 100 can be improved.

Based on the same inventive concept, the present disclosure also provides a cover plate 20, which is the cover plate 20 in the above embodiments.

In some embodiments, the first region 22 of the cover plate 20 is located on both sides of the second region 24, and the cover plate 20 further includes an auxiliary cover plate layer 29, which is provided on one side of the first base 26 away from the flexible display panel 10, a receiving cavity 23 is defined by the flexible display 10 panel, auxiliary cover plate layer 29 and the first base 26. The first base 26 is corresponding to the flat region of the flexible display panel 10, and the second base 28 is corresponding to the bending region of the flexible display panel 10. The second base 28 fills the receiving cavity 23 and is connected to the first base 26; the material of optical clear resin or clear silicone can be injected into the receiving cavity 23 to form the second base 28 connected to the first base 26.

Based on the same inventive concept, the present disclosure further provides a display device, which includes the display screen 100 in the aforementioned embodiments.

Specifically, the display device can be applied to fields such as mobile phone terminals, bionic electronic devices, electronic skins, wearable devices, vehicle-mounted devices, Internet of Things devices, and artificial intelligence devices, etc. For example, the above-mentioned display device can be a digital device such as a mobile phone, a tablet computer, a palmtop computer, an iPod player, and a smart watch, etc.

It should be noted that when describing the positional relationship, unless otherwise specified, when an element such as a layer, a film or a substrate is referred to as being “on” another film layer, it can be directly on the other film layer, or there may be one or more intermediate film layers. Furthermore, when a layer is referred to as being “under” another film layer, it can be directly under the other film layer, or there may be one or more intermediate film layers. It can also be understood that when a film layer is referred to as being “between” two film layers, it can be the only film layer between the two film layers, or there may be one or more intermediate film layers.

The various technical features of the above-mentioned embodiments can be combined arbitrarily. To make the description concise, all possible combinations of the various technical features in the above-mentioned embodiments are not described. However, as long as there is no contradiction in the combination of these technical features, it should be regarded as the scope of the present disclosure.

The above-mentioned embodiments only express several exemplar embodiments of the present disclosure, and the description is relatively specific and detailed, but they cannot therefore be understood as limiting the scope of the present disclosure. It should be pointed out that those of ordinary skill in the art can make several transformations and improvements without departing from the concept of the disclosure, and these all fall within the protection scope of the disclosure. Therefore, the scope of protection of the disclosure shall be subject to the appended claims.

What is claimed is:

1. A display screen, comprising:
a flexible display panel;
a cover plate, having a first region and a second region which is located on at least one side of the first region and contiguous to the first region, wherein the cover plate is configured to be bendable together with the flexible display panel, and the cover plate comprises:
a first base provided in the first region; and
a second base provided in the second region and connected to the first base, wherein an elastic modulus of the first base is greater than an elastic modulus of the second base.

2. The display screen according to claim 1, wherein the second base has a capacity of stress absorption greater than that of the first base.

3. The display screen according to claim 1, wherein a hardness of the first base is greater than a hardness of the second base.

4. The display screen according to claim 1, wherein a flatness of the first base is greater than a flatness of the second base.

5. The display screen according to claim 1, wherein the first region is located on both sides of the second region.

6. The display screen according to claim 1, wherein a material of the first base is toughened glass.

7. The display screen according to claim 6, wherein a thickness of the first base is in a range of 0.1 mm to 1 mm.

8. The display screen according to claim 1, wherein the second base is made of an energy-absorbing material, and the second base completely covers the second region.

9. The display screen according to claim 8, wherein the energy-absorbing material is Optical Clear Resin (OCR) or silica gel.

10. The display screen according to claim 1, wherein the cover plate further comprises an auxiliary cover plate layer which is provided on one side of the first base and the second base away from the flexible display panel.

11. The display screen according to claim 10, wherein the auxiliary cover plate layer at least comprises a flexible glass layer and an organic layer stacked on the flexible glass layer.

12. The display screen according to claim 11, wherein a material of the flexible glass layer is ultra-thin glass.

13. The display screen according to claim 11, wherein a material of the organic layer includes at least one of polyimide, transparent polyamide, polyethylene, and polymethyl methacrylate.

14. The display screen according to claim 1, wherein the flexible display panel comprises a display panel body and a polarizer, and the polarizer is provided between the display panel body and the cover plate.

15. A display device, comprising the display screen according to claim 1.

16. A cover plate, having a first region and a second region which is located on at least one side of the first region and contiguous to the first region, the cover plate comprising:
a first base provided in the first region; and
a second base provided in the second region and connected to the first base, wherein an elastic modulus of the first base is greater than an elastic modulus of the second base.

17. The cover plate according to claim 16, wherein the cover plate is configured to attached to a flexible display panel.

18. The cover plate according to claim 17, wherein the first region is located at both sides of the second region, the cover plate further comprises an auxiliary cover plate layer which is provided on the first base; a receiving cavity is defined by the auxiliary cover plate layer, the first base, and the flexible display panel; and the receiving cavity is completely filled by the second base.

19. The cover plate according to claim 16, wherein the second base has a capacity of stress absorption greater than that of the first base.

20. The cover plate according to claim 16, wherein a hardness of the first base is greater than a hardness of the second base.
